(19) United States
(12) Patent Application Publication
(10) Pub. No.: US 2010/0009264 A1
(43) Pub. Date: Jan. 14, 2010

(54) HIGH RATE DISCHARGE BATTERY CELL

(75) Inventors: Robert John Gordon, Tucson, AZ (US); Kai-Wai Alexander Choi, Houston, TX (US); Cindi Choi, Cupertino, CA (US)

Correspondence Address: FULBRIGHT & JAWORSKI L.L.P., 600 CONGRESS AVE., SUITE 2400, AUSTIN, TX, 78701, US

(73) Assignee: 1ARC Energy, Inc., Cupertino, CA (US)

(21) Appl. No.: 12/169,484

(22) Filed: Jul. 8, 2008

(51) Int. Cl. H01M 6/00; H01M 4/38

(52) U.S. Cl. 429/246; 29/623.3; 29/623.5; 427/123; 429/220; 429/223

(57) ABSTRACT

A high rate discharge battery cell 150 is disclosed. The battery cell 150 comprising an anode end 200 and a cathode end 100 contains: a laminate including at least one anode electrode sheet 102; at least one cathode electrode sheet 101; and at least one separator sheet disposed between the anode electrode sheet 102 and the cathode electrode sheet 101; wherein the anode electrode sheet 102 projects outwardly of the edge of the laminate towards the anode end 200 of the battery cell 300; the cathode electrode sheet 101 projects outwardly of the edge of the laminate towards the cathode end 100 of the battery cell 150; a first current collector 203 in electrical contact with the outwardly projecting part of the anode electrode sheet 102 in the laminate formed by metal spray; and a second current collector 103 in electrical contact with the outwardly projecting part of the cathode electrode sheet 101 in the laminate formed by metal spray. Also disclosed is a method of manufacturing the high rate discharge battery cell.

### TECHNICAL FIELD

The present invention relates generally to battery cell structure. More particularly, aspects of the invention relate to structure of high rate discharge battery cells and methods of manufacturing the same.

### BACKGROUND

Existing battery cells commonly contain a multilayer electrode structure in order to increase the surface area of the electrodes and thereby enhance the electrochemical reaction rate to deliver a larger electric current. The multilayer structure is usually implemented by winding a laminate formed by electrode sheets. Electric current across the electrodes can be collected through a tab disposed in the centre of the battery cell.

Known wound battery cell technologies require cleared strips across the electrode webs when coating the anode and cathode electrodes with active materials. These cleared strips are created to facilitate the tab welding process later in the wound battery cell assembly process. Disadvantageously, the strip coating process requires the coating machine to interrupt the process regularly. For example, such interruption of coating may happen at a fixed distance, usually between 700 to 750 mm. Depending on the coating machine speed, the interruption may occur approximately every 30 seconds. This interruption to the coating process greatly reduces manufacturing rate and dictates the electrode length to be wound in the cell. Furthermore, during the manufacture of wound cell, the winder needs to first locate the cleared area on the electrode web then stop the electrode web and weld a tab to the substrate. This stop/start action on the electrode web slows the winder down, and hence further reduces the production rate considerably.

Additionally, reduced electrical impedance along the electrode web is preferred in battery cells that are required to delivery high currents. To avoid a large voltage drop across the battery cell terminals during high rate discharge which causes undesired heat dissipation in the battery cell, the thickness of electrode substrates in known battery cell structures need to be at least 20-25 microns for the anode and 35-40 microns for the cathode. As a result, it is difficult to reduce size of the battery cell further due to such thickness limitation.

Therefore, the art would benefit greatly from an improved battery cell structure which can get rid of the cleared strip to speed up the manufacturing process. The art would further benefit from improved battery cell structure that can provide lower electrical impedance and hence higher discharge rate, lower heat dissipation, and further reduction of battery cell size.

### SUMMARY

Conventional wound battery cells are usually implemented by installing a tab to collect current from the electrode, therefore requiring a cleared strip on the electrode web for welding the internal tab on the substrate. This requirement undesirably imposes limitations on the production rate of the battery cell. Furthermore, the conventional internal tab collects the current from the complete length of the substrate. This current has to flow along the entire length of the substrate between the tab and the perimeter of the wound battery cell. This unfavorably enhances the internal impedance of the battery cell, which limits the discharge rate and miniaturization of the battery cell structure.

Aspects of the invention solve the foregoing problems by creating current collectors using metal spray technology. According to an embodiment of the claimed invention, electrical connections are created between the edge of the spiral electrode webs (or electrode sheets) and the cap of the cylindrical battery. The presently claimed invention is applicable to wound lithium ion jelly roll batteries.

The metal spray process according to the claimed invention is used in the wound capacitor industries to make electrical connections between the wound capacitor and the external can components. This is a standard process in the capacitor industry and is used by numerous manufacturers that build wound capacitors. The process includes taking wire electrodes and passing an electric current between them to melt the ends of the electrodes. A pressurized air jet is directed on the molten ends of the wires and the resulting spray of molten metal is deposited onto the wound electrode.

It is an object of the presently claimed invention to remove internal tabs of the wound battery cell. According to an embodiment of the claimed invention, electrical connection is made to the wound edge of the anode and to the opposite wound edge of the cathode by metal spray. The resulting current collectors collect current across the electrodes from the entire edge of the substrate.

It is another object of the presently claimed invention to reduce the internal impedance of the battery cell. According to an embodiment of the claimed invention, the electric current travels between the entire edges of the substrates. This corresponds to a shorter electrical path across the electrodes as opposed to the path along the electrodes in conventional battery cell structure. In an exemplary embodiment, the battery cell can deliver a higher current due to the reduced internal impedance. In another exemplary embodiment, the substrates used in the anode and cathode can be much thinner under the same internal impedance, thus allowing miniaturization of battery cell size. In a further exemplary embodiment, the thickness reduction of electrodes can lead to lower costs for non-active materials in the wound cell and a greater volume of active materials which yields battery cells with higher capacities. The non-active materials include the copper and aluminum substrates which are disposed inside the cell to carry the electric current into and out of the cell during charge and discharge. Such non-active materials do not contribute to the electrical capacity of the cell. On the other hand, the active materials include the anode coating that is applied to the copper substrate, the cathode coating that is applied to the aluminum and the electrolyte. These active materials are the ones that provide the cell capacity or total energy that the cell can contain.

It is a further object of the presently claimed invention to lower the internal heating effect of the wound battery cell during high current discharge by reducing the internal impedance.

It is yet another object of the presently claimed invention to remove the current collecting tabs inside the wound cell and to provide extra volume for the active electrode. This will allow more active material in the same volume and so increase capacity of the battery cell.

Accordingly, several aspects of the invention have been developed with a view to substantially reduce or eliminate the drawbacks described hereinbefore and known to those skilled in the art and to provide an improved battery cell structure that may provide lower internal impedance, higher discharge rate, lower heating effect, and be manufactured by faster, more simplified, and lower cost processes than presently employed. In certain embodiments, the battery cell with an anode end and a cathode end contains a laminate. The laminate includes at least one anode electrode sheet; at least one cathode electrode sheet; and at least one separator sheet disposed between the anode electrode sheet and the cathode electrode sheet. The anode electrode sheet projects outwardly of the edge of the laminate towards the anode end of the battery cell, while the cathode electrode sheet projects outwardly of the edge of the laminate towards the cathode end of the battery cell. The battery cell further contains a first current collector in electrical contact with the outwardly projecting part of the anode electrode sheet in the laminate formed by metal spray; and a second current collector in electrical contact with the outwardly projecting part of the cathode electrode sheet in the laminate formed by metal spray.

According to one embodiment of the claimed invention, the laminate is wound to form a cylinder structure before metal spray such that the outwardly projecting part of the anode electrode sheet and the outwardly projecting part of the cathode electrode sheet are at opposite longitudinal ends of the cylinder structure.

According to an embodiment, the first current collector is formed by spraying metal selected from the group consisting of copper and nickel. In another embodiment, the second current collector is formed by spraying metal selected from the group consisting of aluminum. Advantageously, the first current collector and the second current collector are disc structures respectively covering the longitudinal ends of the battery cell. In one embodiment of the claimed invention, the disc structures are porous and advantageously provide an easy path for filling the electrolyte into the batter cell. In another embodiment of the claimed invention, the disc structures may be non-porous.

According to a second aspect of the claimed invention, there is provided a method of manufacturing battery cells with an anode end and a cathode end, comprising at least one anode electrode sheet, at least one cathode electrode sheet, and at least one separator sheet. The method includes stacking the anode electrode sheet, the cathode electrode sheet and the separator sheet to form a laminate such that the anode electrode sheet projects outwardly of the edge of the laminate towards the anode end of the battery cell whereas the cathode electrode sheet projects outwardly of the edge of the laminate towards the cathode end of the battery cell. The method further includes spraying metal to form a first current collector and a second collector, such that the first current collector is in electrical contact with the outwardly projecting part of the anode electrode sheet in the laminate; and the second current collector is in electrical contact with the outwardly projecting part of the cathode electrode sheet in the laminate.

In one embodiment, the spraying metal further includes: passing an electric current along a first metal wire, across a gap, and into a second metal wire to generate metal droplets; moving the first metal wire and said second metal wire towards the gap; and directing air flow at the gap to spray the metal droplets.

In another embodiment, the electric current is in the range of 20 amperes to 200 amperes. In a further embodiment, the first metal wire and second metal wire is moved at the speed in the range of 5 centimeters per minute to 100 centimeters per minute.

In one embodiment, the air flow is created by air pressure in the range of 20 psi to 120 psi. In another embodiment, the air flow is diverging in the range of 15 degrees to 90 degrees.

In a further embodiment, the method preferably includes winding the laminate to form a cylinder structure before spraying metal, such that the outwardly projecting part of the anode electrode sheet and the outwardly projecting part of the cathode electrode sheet are at opposite longitudinal ends of the cylinder structure.

In one embodiment, the first current collector is formed by spraying copper or nickel, whereas the second current collector is formed by spraying aluminum. In another embodiment, the first current collector and the second current collector are formed as disc structures by spraying metal such that the disc structures respectively cover the longitudinal ends of the battery cell. According to another embodiment, the first current collector and the second current collector are formed as porous disc structures by spraying metal. According to yet another embodiment, the first current collector and the second current collector are formed as non-porous disc structures by spraying metal.

Other aspects of the invention are also disclosed.

### BRIEF DESCRIPTION OF DRAWINGS

Embodiments of the invention are described in more detail hereinafter with reference to the drawings, in which:

FIG. 1A is a cross-sectional view of an exemplary current collector formed by metal spray to the cathode according to an embodiment of the claimed invention.

FIG. 1B is a cross-sectional view of an exemplary current collector formed by metal spray to the cathode according to another embodiment of the claimed invention.

FIG. 2A is a cross-sectional view of an exemplary current collector formed by metal spray to the anode according to an embodiment of the claimed invention.

FIG. 2B is a cross-sectional view of an exemplary current collector formed by metal spray to the anode according to another embodiment of the claimed invention.

FIG. 3A illustrates a metal spray setup according to an embodiment of the claimed invention.

FIG. 3B is a perspective view of a spray metal assembly according to an embodiment of the claimed invention.

FIG. 4 is a perspective view of the cathode end of a battery formed by Aluminum metal spray according to an embodiment of the claimed invention.

FIG. 5 is a perspective view of the anode end of a battery formed by Copper metal spray according to an embodiment of the claimed invention.

FIG. 6 is a flow diagram illustrating the method of manufacturing battery cell in accordance with an embodiment of the claimed invention.

### DETAILED DESCRIPTION

Improved assembly structures for battery cell and corresponding manufacturing process are disclosed herein. In the following description, numerous specific details, including parameters of manufacturing processes, chemicals, dimensions, and the like are set forth. However, from this disclosure, it will be apparent to those skilled in the art that modifications, including additions and/or substitutions may be made without departing from the scope and spirit of the invention. In other circumstances, specific details may be omitted so as not to obscure the invention. Nonetheless, the disclosure is written as to enable one skilled in the art to practice the teachings of the embodiments of the invention without undo experimentation.

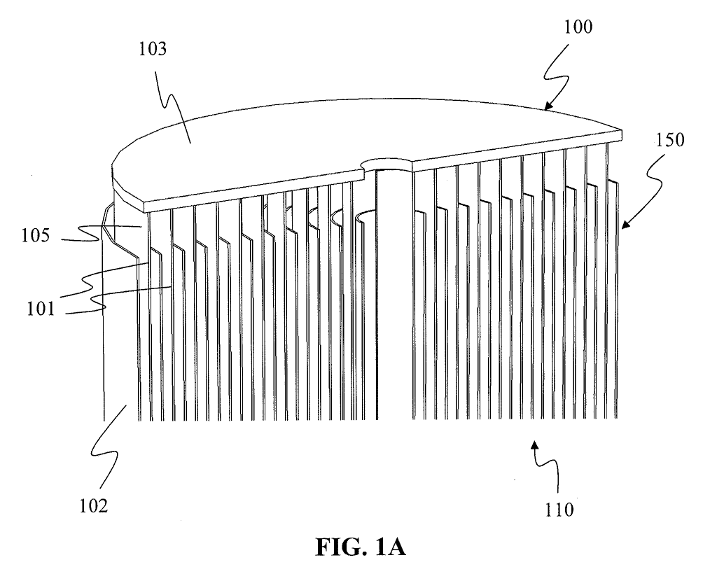

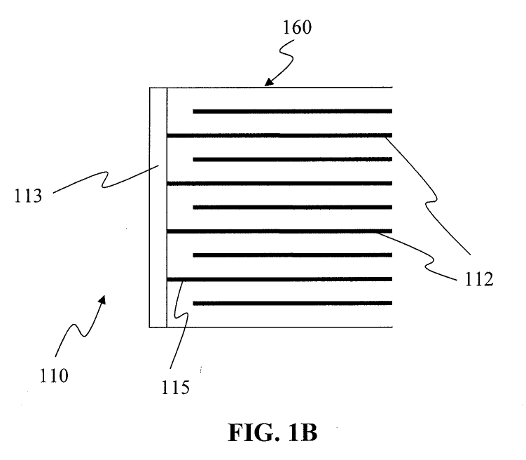

FIG. 1A shows a cross-sectional view of an exemplary current collector 103 formed by metal spray to the cathode 100 according to an embodiment of the claimed invention. According to an exemplary embodiment, the battery cell includes a laminate which is formed by stacking at least one anode electrode sheet 102, at least one cathode electrode sheet 101, and at least one separator sheet (not shown) between the electrode sheets 101, 102. The laminate is prepared in such a way that the cathode electrode sheet 101 projects outwardly of the edge of the laminate towards the cathode end 100 of the battery cell 150.

In one exemplary embodiment of the claimed invention, the laminate is further wound into a cylinder structure such that the outwardly projecting part 105 of the cathode electrode sheet 101 locates at the cathode end of the cylinder structure. A current collector 103 at the cathode end is formed by spraying metal to create electrical contact with the edge of the outwardly projecting part 105 of the cathode electrode sheet in the laminate. According to an embodiment of the invention, the current collector 103 is in disc shape and covers wholly the cathode end 100 of the cylindrical battery cell 150.

In one exemplary embodiment, the metal spray process deposits metal droplets to form a layer of conducting material as current collector 103 interconnecting the electrode sheets 101. In one exemplary embodiment, the electrode sheet 101 is aluminum substrate and the metal spray process deposits aluminum molten droplets unto the projecting edge 105 of the aluminum substrate such that the resulting aluminum disc contacts the complete edge of the aluminum substrate. In a further embodiment, the current collector 103 in disc form is made porous by manipulating the metal spray parameters, such as current, wire speed, air flow rate and direction of air flow. This porous aluminum disc as current collector 103 allows current to flow into and out of the anode electrode sheet 102 and provides an easy path for filling the electrolyte into the wound cell 150. The holes of the porous disc need to be large enough to allow electrolyte flow through but not so large that the structure becomes mechanically week or restricts the electrical current.

FIG. 1B shows a cross-sectional view of an exemplary current collector 113 formed by metal spray to the cathode 110 according to another embodiment of the claimed invention. In this exemplary embodiment, the laminate remains in planar form and the outwardly projecting part 115 of the anode electrode sheet 112 is interconnected by metal spraying in a similar manner. A current collector 113 at the cathode end 110 is formed as electrical contact interconnecting the edge of the outwardly projecting part 115 of the cathode electrode sheet 112 in the laminate. According to an embodiment of the invention, the current collector 113 is a rectangular plate that covers the whole cathode end 110 of the battery cell 160.

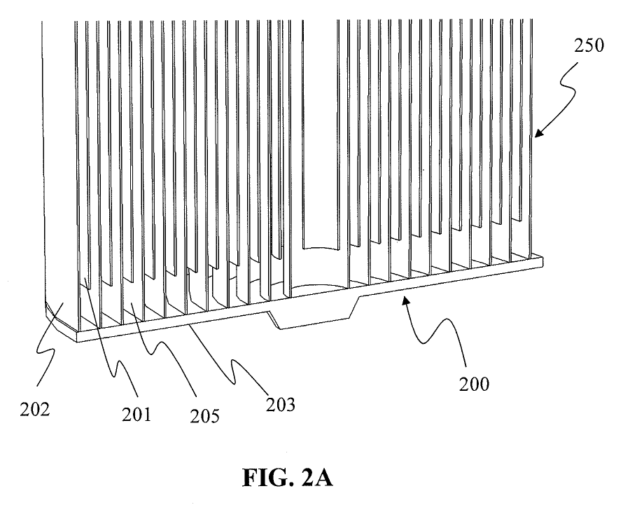

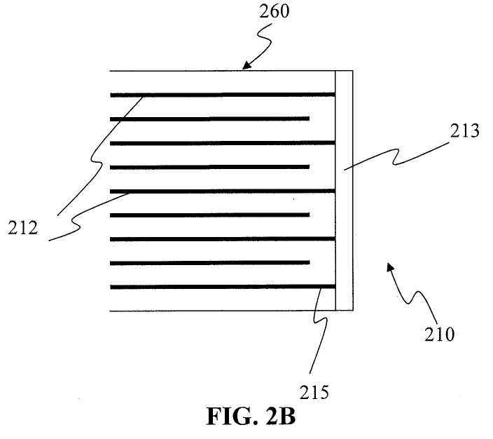

FIG. 2A shows a cross-sectional view of an exemplary current collector 203 formed by metal spray to the anode 200 according to an embodiment of the claimed invention. According to an exemplary embodiment, the battery cell includes a laminate which is similar to that in FIG. 1 and is formed by stacking at least one anode electrode sheet 202, at least one cathode electrode sheet 201, and at least one separator sheet (not shown) between the electrode sheets 201, 202. The laminate is constructed in such a way that the anode electrode sheet 201 projects outwardly of the edge of the laminate towards the anode end 200 of the battery cell 250.

In one exemplary embodiment of the claimed invention, the laminate is further wound into a cylinder structure in a similar manner as in FIG. 1 such that the outwardly projecting part 205 of the anode electrode sheet 202 forms a coil at the anode end of the cylinder structure. A current collector 203 at the anode end can then be created by spraying metal unto the edge of the outwardly projecting part 205 of the anode electrode sheet 202 in the laminate in order to electrically connect the anode electrode sheet. According to an embodiment of the invention, the current collector 203 is in disc shape and covers wholly the anode end 200 of the cylindrical battery cell 250.

The metal spray process deposits a layer of conducting material as current collector 203 interconnecting the anode electrode sheets 202. In one exemplary embodiment, the anode electrode sheet 202 is copper substrate and the metal spray process deposits copper or nickel molten droplets unto the projecting edge 205 of the copper substrate such that the resulting copper or nickel disc contacts the complete edge of the copper substrate. In a further embodiment, the copper or nickel current collector 203 in disc form is made porous by manipulating the metal spray parameters, such as current, wire speed, air flow rate and direction of air flow. This porous copper or nickel disc as current collector 203 allows current to flow into and out of the cathode electrode sheet 202 and provides an easy path for filling the electrolyte into the wound cell 250. The holes of the porous disc need to be large enough to allow electrolyte flow through but not so large that the structure becomes mechanically week or restricts the electrical current.

FIG. 2B shows a cross-sectional view of an exemplary current collector 213 formed by metal spray to the anode 210 according to another embodiment of the claimed invention. In this exemplary embodiment, the laminate remains in planar form and the outwardly projecting part 215 of the anode electrode sheet 212 is interconnected by metal spraying in a similar manner. A current collector 213 at the anode end 210 is formed as electrical contact interconnecting the edge of the outwardly projecting part 215 of the cathode electrode sheet 212 in the laminate. According to an embodiment of the invention, the current collector 213 is a rectangular plate that covers the whole anode end 210 of the battery cell 260.

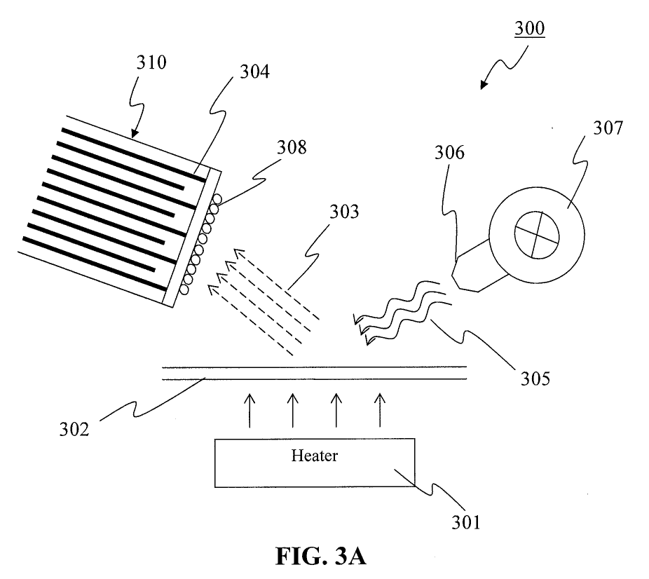

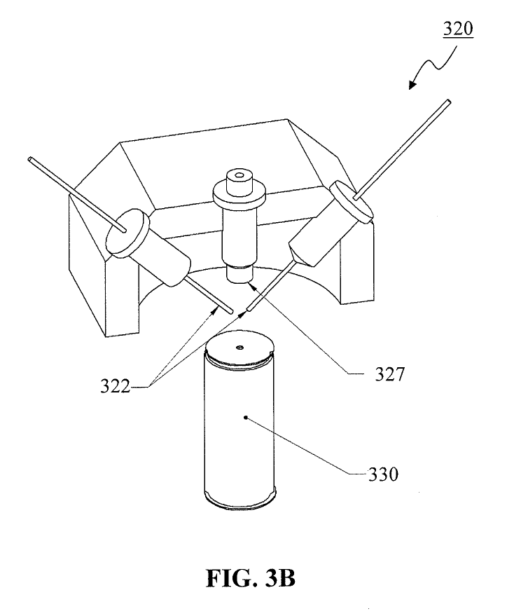

FIG. 3A illustrates a metal spray setup 300 according to an embodiment of the claimed invention. In this exemplary embodiment, the metal spray setup 300 generally includes a heater for heating the metal, preferably a metal wire 302, into molten state. The atomized metal 303 is subsequently sprayed on to the projecting edges of electrode sheets 304 by gas stream 305. The heating process can be implemented by a number of ways, including oxy-acetylene flame, pulsed-arc, spray-arc and direct-current arc. For the case of direct-current arc, the temperature can be adjusted by manipulating the current flowing through the electrodes in the welding head that generates the arc. Additionally, the gas stream 305 can be generated by pressurized gas emitted in a controllable manner, such as flow rate and flow angle, through a nozzle 306. As the gas stream is directed towards the melting metal, a stream of atomized metal 303 is created which flows away from the welding head.

In one exemplary embodiment, the metal spray setup 300 deposits metal droplets to form a layer of conducting material as current collector 308 interconnecting the electrode sheets 304. In one exemplary embodiment, the metal spray process deposits molten metal droplets unto the projecting edge of the electrode sheets 304 such that the resulting metal disc electrically contacts the complete edge of the electrode sheets 304. In a further embodiment, the current collector 308 in disc form is made porous by manipulating the metal spray parameters, such as current, wire speed, air flow rate and direction of air flow. In an exemplary embodiment, the metal spray parameters include: the temperature of the heater 301; air pressure of the air jet 307, ranging substantially from 20 psi to 120 psi; the direction of flow of the air as determined by the size of battery cell and can be adjusted by the air jet 307 arrangement. In another exemplary embodiment, the air flow is a cone of diverging flow that substantially ranges from 15 degrees to 90 degrees.

The porous metal disc as current collector 308 allows current to flow into and out of the electrode sheet 304 and provides an easy path for filling the electrolyte into the battery cell 310. When the wire 302 melts and is blown by the air jet 307, it forms small spherical balls as metal spray 303. The average diameter of these spherical balls depends on the electric current, air flow and the profile of the air jet 307. As the spherical balls in the metal spray 303 strike the battery cell 310, they welt together into flattened metal balls. The flattened balls are welded together where they touch and have gaps where they do not touch. The electric current that presents during charge and discharge can easily flow across the welded ball contacts and into and out of the electrodes 304. Furthermore, the gap between the balls results in a porous structure that allows liquid electrolyte to flow into the electrodes 304.

One advantage offered by metal spray to interconnect the electrode sheets 304 is that the process does not melt the electrode sheets 304. The temperature of the atomized metal stream can be adjusted through the heating power of the welding head or the heater 301, and gas flow rate of the air jet 307 such that the metal droplets in the metal spray 303 cool down to an appropriate temperature upon arriving at the target deposit surface from the molten metal 302. This appropriate temperature shall allow the metal droplets depositing on the electrode sheets 304 while avoid melting the same.

FIG. 3B shows a perspective view of a spray metal assembly 320 according to an embodiment of the claimed invention. In this exemplary embodiment, molten metal droplets are generated by electric current flowing along and across two metal wires 322. The wires 322 are the current carriers and the spark across the ends due to high electrical potential difference generates the heat to melt the wires 322. The center air jet 327 blows the molten metal droplets onto the end of the wound cell 330. The average diameter of these spherical molten metal droplets depends on the electric current along the two wires 322 ranging substantially from 20 amps to 200 amps; the speed of the metal wires moving towards the gap, ranging substantially from 5 centimeters per minute to 100 centimeters per minute; air pressure of the air jet 327, ranging substantially from 20 psi to 120 psi; the direction of flow of the air as determined by the size of battery cell and can be adjusted by the air jet 327 arrangement. In another exemplary embodiment, the air flow is a cone of diverging flow that substantially ranges from 15 degrees to 90 degrees.

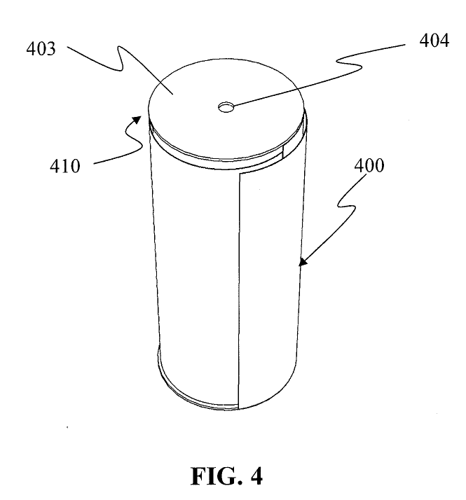

FIG. 4 shows a perspective view of the cathode end 410 of a battery cell 400 formed by aluminum metal spray according to an embodiment of the claimed invention. In an exemplary example, the cathode end includes a layer of aluminum that is deposited to form the current collector 403. The layer of aluminum forms a complete disc that contributes a continuous electrical contact with the projecting edge of the cathode electrode sheet. The aluminum disc as current collector 403 has an open structure 404 to enable the transfer of electrolyte into the wound battery cell 400. For a cell with non-porous discs, the electrolyte is filled through the center open structure 404. This may be a slow process compared to filling through porous discs, as the electrolyte may have to travel through the separator as it spirals through the wound structure.

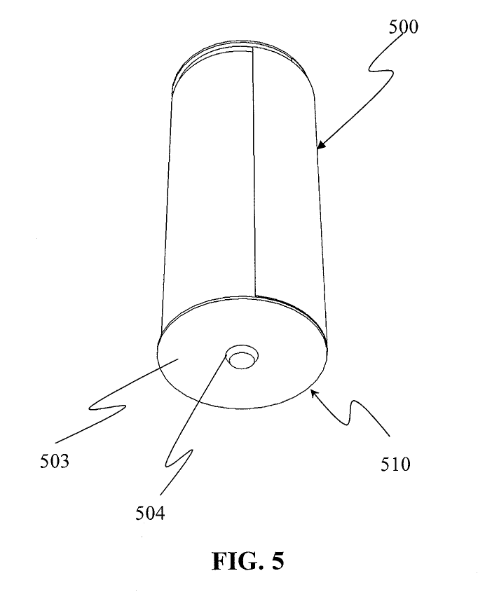

FIG. 5 is a perspective view of the anode end 510 of a battery cell 500 formed by copper or nickel metal spray according to an embodiment of the claimed invention. In an exemplary example, the anode end 510 includes a layer of copper or nickel that is deposited to form the current collector 503. The layer of copper or nickel forms a complete disc that contributes a continuous electrical contact with the projecting edge of the anode electrode sheet. The copper or nickel disc has an open structure 504 to enable the transfer of electrolyte into the wound battery cell 500. For a cell with non-porous discs, the electrolyte is filled through the center open structure 504. This may be a slow process compared to filling through porous discs, as the electrolyte may have to travel through the separator as it spirals through the wound structure.

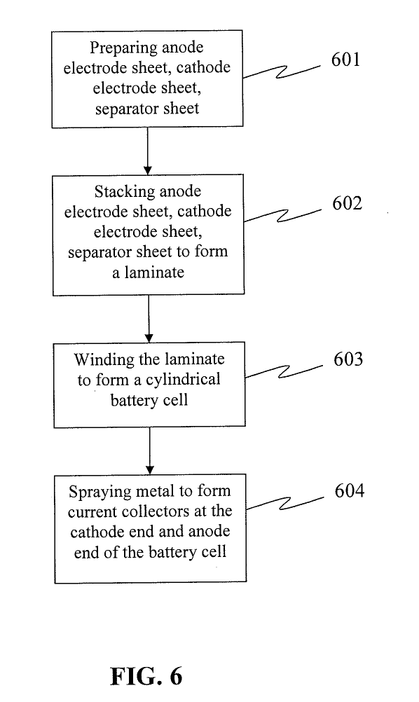

FIG. 6 is a flow diagram illustrating the method of manufacturing battery cell in accordance with an embodiment of the claimed invention. At step 601, at least one anode electrode sheet, at least one cathode electrode sheet, and at least one separator sheet is prepared. In an exemplary embodiment, the anode electrode sheet is made of aluminum, whereas the cathode electrode sheet is made of copper.

At step 602, the anode electrode sheet, cathode electrode sheet and separator sheet are stacked together to form a laminate with the separator sheet disposed between the two electrode sheets. Furthermore, the anode electrode sheet projects outwardly of the edge of the laminate towards the anode end of the battery cell. Similarly, the cathode electrode sheet projects outwardly of the edge of the laminate towards the cathode end of the battery cell.

At step 603, the laminate is wound to form a cylinder structure before spraying metal. The resulting cylinder structure has the outwardly projecting part of the anode electrode sheet and the outwardly projecting part of the cathode electrode sheet at opposite longitudinal ends.

At step 604, metal droplets are sprayed to form a first current collector and a second collector on the respective ends of the battery cell. The first current collector locates at the anode end and electrically contacts with the outwardly projecting part of the anode electrode sheet in the laminate. In an exemplary embodiment, the first current collector is formed by copper or nickel metal spray. Similarly, the second current collector is in electrical contact with the outwardly projecting part of the cathode electrode sheet in the laminate. In an exemplary embodiment, the second current collector is formed by aluminum metal spray. In a further exemplary embodiment, the current collectors are formed as porous disc structures.

The foregoing description of embodiments of the present invention are not exhaustive and any update or modifications to them are obvious to those skilled in the art, and therefore reference is made to the appending claims for determining the scope of the present invention.

1. A battery cell with an anode end and a cathode end, comprising:
a laminate including at least one anode electrode sheet; at least one cathode electrode sheet; and at least one separator sheet disposed between said anode electrode sheet and said cathode electrode sheet; wherein said anode electrode sheet projects outwardly of the edge of said laminate towards the anode end of said battery cell; said cathode electrode sheet projects outwardly of the edge of said laminate towards the cathode end of said battery cell;
a first current collector in electrical contact with the outwardly projecting part of said anode electrode sheet in said laminate formed by metal spray; and
a second current collector in electrical contact with the outwardly projecting part of said cathode electrode sheet in said laminate formed by metal spray.

2. The battery cell according to claim 1, wherein said laminate is wound to form a cylinder structure before metal spray such that said outwardly projecting part of said anode electrode sheet and said outwardly projecting part of said cathode electrode sheet are at opposite longitudinal ends of said cylinder structure.

3. The battery cell according to claim 1, wherein said first current collector is formed by spraying metal selected from the group consisting of copper and nickel.

4. The battery cell according to claim 1, wherein said second current collector is formed by spraying metal selected from the group consisting of aluminum.

5. The battery cell according to claim 2, wherein said first current collector and said second current collector are disc structures respectively covering the longitudinal ends of the battery cell.

6. The battery cell according to claim 5, wherein said disc structures are porous.

7. The battery cell according to claim 5, wherein said disc structures are non-porous.

8. A method of manufacturing battery cell with an anode end and a cathode end, comprising at least one anode electrode sheet, at least one cathode electrode sheet, and at least one separator sheet, comprising:
stacking said anode electrode sheet, said cathode electrode sheet and said separator sheet to form a laminate, wherein said anode electrode sheet projects outwardly of the edge of said laminate towards the anode end of the battery cell; and said cathode electrode sheet projects outwardly of the edge of said laminate towards the cathode end of the battery cell; and
spraying metal to form a first current collector and a second collector, wherein said first current collector is in electrical contact with the outwardly projecting part of said anode electrode sheet in said laminate; and said second current collector is in electrical contact with the outwardly projecting part of said cathode electrode sheet in said laminate.

9. The method of manufacturing battery cell according to claim 8, wherein said spraying metal to form a first current collector and a second collector further comprises:
passing an electric current along a first metal wire, across a gap, and into a second metal wire to generate metal droplets;
moving said first metal wire and said second metal wire towards said gap; and
directing air flow at said gap to spray said metal droplets.

10. The method of manufacturing battery cell according to claim 9, wherein said electric current is in the range of 20 amperes to 200 amperes.

11. The method of manufacturing battery cell according to claim 9, wherein said moving said first metal wire and said second metal wire is at the speed in the range of 5 centimeters per minute to 100 centimeters per minute.

12. The method of manufacturing battery cell according to claim 9, wherein said directing air flow is created by air pressure in the range of 20 psi to 120 psi.

13. The method of manufacturing battery cell according to claim 9, wherein said directing air flow is diverging air flow in the range of 15 degrees to 90 degrees.

14. The method of manufacturing battery cell according to claim 8, further comprising winding said laminate to form a cylinder structure before spraying metal, such that said outwardly projecting part of said anode electrode sheet and said outwardly projecting part of said cathode electrode sheet are at opposite longitudinal ends of said cylinder structure.

15. The method of manufacturing battery cell according to claim 8, wherein said spraying metal to form said first current collector is spraying metal selected from the group consisting of copper and nickel.

16. The method of manufacturing battery cell according to claim 8, wherein said spraying metal to form said second current collector is spraying metal selected from the group consisting of aluminum.

17. The method of manufacturing battery cell according to claim 14, wherein said spraying metal forms said first current collector and said second current collector as disc structures respectively covering the longitudinal ends of the battery cell.

18. The method of manufacturing battery cell according to claim 17, wherein said spraying metal forms said first current collector and said second current collector as porous disc structures.

19. The method of manufacturing battery cell according to claim 18, wherein said spraying metal forms said first current collector and said second current collector as non-porous disc structures.
